(19) United States
(12) Patent Application Publication
(10) Pub. No.: US 2020/0291552 A1
(43) Pub. Date: Sep. 17, 2020

(54) METHOD FOR THE PREPARATION OF A POLYMERIC MATERIAL

(71) Applicant: SAINT-GOBAIN PERFORMANCE PLASTICS FRANCE, Charny Oree de Puisaye (FR)

(72) Inventors: Nicolas Dumont, Gradignan (FR); Gaëtan Mao, Pessac (FR)

(21) Appl. No.: 16/815,103

(22) Filed: Mar. 11, 2020

(30) Foreign Application Priority Data
Mar. 11, 2019 (FR) 1902450

(51) Int. Cl. D04B 1/16; B29B 11/16; B29C 70/30; D04B 1/22

(52) U.S. Cl. CPC D04B 1/16; B29B 11/16; B29K 2101/12; D04B 1/22; B29C 70/30

(57) ABSTRACT

The present disclosure relates to a method for manufacturing a product comprising at least one zone made of polymeric material, in particular thermoplastic, from a dry knitted preform. The dry preform is produced in three dimensions, by weft knitting of a continuous piece corresponding to the shape of the finished product to be obtained. The preform is then consolidated by heating under pressure in a mold and then cooled. The method according to the invention is particularly advantageous because it makes it possible to obtain parts of polymeric material of controlled thickness; the finished products have no connection and require no assembly of different parts. The method does not cause any loss or drop of material. The method according to the invention is not accompanied by any release of toxic volatile elements at ambient temperature.

### CROSS-REFERENCE TO RELATED APPLICATION(S)

This Application claims priority under 35 U.S.C. § 119(a)-(d) to French Patent Application No. 1902450, entitled “METHOD FOR THE PREPARATION OF A POLYMERIC MATERIAL,” by Nicolas DUMONT et al, filed Mar. 11, 2019, which is assigned to the current assignee hereof and incorporated herein by reference in its entirety.

### FIELD OF THE DISCLOSURE

The present disclosure relates to a method for preparation of a polymeric material and the manufacturing of a product from the polymeric material. The present disclosure relates to the field of products made mainly of polymeric material. By polymeric material is meant, in particular, thermoplastic materials. The invention therefore does not, as such, relate to composite products consisting of a matrix and a reinforcing structure, generally made of fibers. The products according to the invention can however be combined with a composite product.

BACKGROUND

According to traditional methods, to obtain a piece of polymeric material, it is necessary either to deform a sheet of pure polymer (thermoforming), or to inject polymeric material into a mold (injection).

In thermoforming of a thermoplastic material, the material in the form of a plate is heated to soften it, and shaped with a mold. The material hardens when it cools, keeping this shape.

The disadvantages of this method are that: the final shape cannot be too complex because it must be obtainable by stamping; the final thickness of the product depends on the shape and direction of the deformation, meaning that it cannot be adjusted; and, the thickness of the initial plate depends on the zone that is to undergo the most deformation, which induces extra thickness in the zones to undergo less deformation.

In injection, it is possible to obtain complex 3D shapes but the tools to produce them are very expensive.

The disadvantages of this method are that: it is not suitable for the production of small or medium series; and, it does not allow the use of continuous fibers.

### BRIEF DESCRIPTION OF THE DRAWINGS

Embodiments are illustrated by way of example and are not limited to the accompanying figures.

FIG. 1 includes an illustration of a front view of an object of complex shape that includes a polymeric material.

FIG. 2 includes an illustration of a side view of an object of complex shape that includes of polymeric material.

FIG. 3 includes an illustration showing a preform that includes a composite part and a part made of polymeric material only.

FIG. 4 includes an illustration showing the finished product obtained from the preform of FIG. 3.

FIG. 5 includes an illustration schematically depicting a composite object coated with a layer of polymeric material.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

According to particular embodiments, it has been discovered that it is possible to use technical knitting methods to form a dry preform in 3D, using yarns that may include 90% to 100% of polymeric material by volume, or even using yarns that may include only polymeric material. The preform is then fully consolidated by heating.

For purposes of embodiments described herein, the term “dry preform” means a product obtained by generally knitting a continuous yarn in which the yarn forms intertwined stitches, arranged in successive rows.

The production of the preform can generally require a spool of yarn for the yarn mesh. Different knitting techniques can make it possible to obtain knits forming a unitary piece, in 3D, seamless, of variable local surface mass.

Particular knitting techniques allow circular knitting or straight knitting to be carried out.

A distinction can be made between weft knitting methods and warp knitting methods.

Documents US 2016/0075061 A1, US 2017/0157865 A1 and EP 0 630 735 A2 relate to composite materials, comprising a matrix of polymeric material and a reinforcement structure whose melting point is higher than the melting point of the matrix. Generally, the matrix can represent 50% to 85% of the volume of the final product; the reinforcement structure can represent 15% to 50% of the volume of the final product. In EP 0 630 735, the fiber content, in the exemplary embodiments, the reinforcement structure can represent from 50% to 80% for only 20% to 50% of polymeric material.

According to particular embodiments, the present invention relates to a method for manufacturing a product that may include a polymeric material. According to certain embodiments, the method according to the invention may include at least the following steps: weft knitting of a yarn or a set of yarns made from 90% to 100% polymeric material by volume; production of a dry preform in three dimensions, and in a continuous piece, the preform corresponding to the shape of the finished product to be obtained; consolidation of the preform by heating under pressure to reach at least the melting point temperature of the polymeric material; cooling of the product thus obtained.

According to certain embodiments, knitting can be done by a straight or a circular knitting method.

According to still other embodiments, the preform advantageously may include a single piece, seamless, of local surface mass adapted to the desired final thickness.

According to yet other embodiments, advantageously, the knitting can be carried out by straight knitting which makes it possible to obtain complex 3D shapes, which would not be the case with circular knitting.

According to particular embodiments, the “polymeric material” can mean thermoplastic materials, such as, polycarbonate, polypropylene, polyamide, polyurethane, PMMA, low density polyethylene terephthalate, polyetherimide, polyetheretherketone (PEEK), polyetherketoneketone (PEKK), etc, or combination thereof.

According to still other embodiments, in particular, in at least one zone of the final product, the polymeric material can represents from 95% to 100% by volume, or even 100% by volume.

According to yet other embodiments, advantageously, the dry preform can be produced with densities of 2 rows/cm to 7 rows/cm, preferably 3 rows/cm to 6 rows/cm and 2 columns/cm to 3 columns/cm.

According to yet other embodiment, advantageously, the dry preform can have a weight per unit area of 100 g/m² to 1500 g/m², preferably from 500 g/m² to 1300 g/m ²

According to certain embodiments, the polymer may include fillers, which can be added at the stage of formulation of the polymer or of spinning of the yarn.

According to certain embodiments, such fillers can be, for example, colored pigments or static electricity dissipators.

According to an alternative embodiment, the preform can constitute a specific non-composite zone of a final product that may include another zone of composite material. The specific non-composite zone can constitute a surface coating or a layer of polymeric material to assemble two distinct objects.

The invention therefore advantageously makes it possible to replace the overmolding methods or to form a coat of paint or a layer of glue or can constitute a surface layer prior to the application of a final paint.

According to certain embodiments, the preform can be made with a colored yarn which puts the final color directly into the mass of the finished product, without the need to add a coat of paint.

According to yet other embodiments, the invention can also relate to the use of a dry preform obtained by knitting a straight weft in 3D, for the manufacture of a product comprising at least one zone comprising from 90% to 100% by volume of polymeric material, preferably 95% at 100% by volume of polymeric material, or even 100% by volume of polymeric material.

The method according to the invention is particularly advantageous because the finished products have a controlled thickness; they have no seams (therefore continuity of the aerodynamic profile). The method does not require any assembly of different parts. The method does not cause any loss or drop of material. The method according to the invention is not accompanied by any release of toxic volatile elements at ambient temperature.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A method for manufacturing a polymeric product, wherein the method comprises the following steps: a) weft knitting a yarn or a set of yarns, wherein the yarn or set of yarns comprise 90% to 100% polymeric material by volume;

b) production of a dry preform in three dimensions, and in a continuous piece; the preform corresponding to the shape of a finished product to be obtained;
c) consolidation of the preform by heating under pressure to reach at least the melting point temperature of the 90% to 100% polymeric material, and
d) cooling of the finished product.

Embodiment 2. The method according to embodiment 1, wherein the weft knitting is carried out by knitting a straight weft.

Embodiment 3. The method according to any one of embodiments 1 and 2, wherein at least one zone of the final product comprises 95% to 100% polymeric material by volume.

Embodiment 4. The method according to any one of the preceding embodiments, wherein the polymeric material is chosen from polycarbonate, polypropylene, polyamide, polyurethane, PMMA, low density polyethylene terephthalate, polyetherimide, polyetheretherketone (PEEK), polyetherketone ketone (PEKK), or combinations thereof.

Embodiment 5. The method according to any one of the preceding embodiments, wherein the dry preform is produced with densities from 2 rows/cm to 7 rows/cm, preferably from 3 rows/cm to 6 rows/cm and from 2 columns/cm to 3 columns/cm.

Embodiment 6. The method according to any one of the preceding embodiments, wherein the dry preform has a weight per unit area of 100 g/m² to 1500 g/m², preferably from 500 g/m ² to 1300 g/m².

Embodiment 7. The method according to any one of the preceding embodiments, wherein, after step b), the dry preform of polymeric material is deposited on a preform intended to form a composite product, and wherein step c) further comprises allowing the consolidation of the two preforms together.

Embodiment 8. The method according to any one of embodiments 1, 2, 3, 4, 5 and 6, wherein, after step b), the dry preform of polymeric material is deposited on a composite part previously consolidated, and wherein step c) further comprises allowing the melting of the dry preform and the consolidation or adhesion of the dry preform to the composite part together.

Embodiment 9. The method according to any one of the preceding embodiments, wherein the yarn or yarns comprise fillers, added to the step of formulation of the polymer or of the spinning of the yarn.

Embodiment 10. The method according to embodiment 9, wherein the fillers comprise colored pigments.

Embodiment 11. The method according to embodiment 9, wherein the fillers comprise static electricity dissipators.

Embodiment 12. The use of a dry preform obtained by knitting a rectilinear weft in 3D for the manufacture of a product, wherein the product comprises at least one zone comprising 90% to 100% polymeric material by volume.

Embodiment 13. The use of a dry preform obtained by knitting a rectilinear weft in 3D to coat a composite product of a layer comprising 90% to 100% of polymeric material by volume.

Embodiment 14. The use of a dry preform obtained by knitting a rectilinear weft in 3D to assemble two distinct objects.

Embodiment 15. A method for manufacturing a polymeric product, wherein the method comprises the following steps: a) weft knitting a yarn or a set of yarns, wherein the yarn or set of yarns comprise 90% to 100% polymeric material by volume; b) production of a dry preform in three dimensions, and in a continuous piece; the preform corresponding to the shape of a finished product to be obtained; c) consolidation of the preform by heating under pressure to reach at least the melting point temperature of the 90% to 100% polymeric material, and d) cooling of the finished product.

Embodiment 16. The method of embodiment 15, wherein the weft knitting is carried out by knitting a straight weft.

Embodiment 17. The method of embodiment 15, wherein at least one zone of the final product comprises 95% to 100% polymeric material by volume.

Embodiment 18. The method of embodiment 17, wherein the polymeric material is chosen from polycarbonate, polypropylene, polyamide, polyurethane, PMMA, low density polyethylene terephthalate, polyetherimide, polyetheretherketone (PEEK), polyetherketone ketone (PEKK), or combinations thereof.

Embodiment 19. The method of embodiment 15, wherein the dry preform is produced with densities from 2 rows/cm to 7 rows/cm, preferably from 3 rows/cm to 6 rows/cm and from 2 columns/cm to 3 columns/cm.

Embodiment 20. The method of embodiment 15, wherein the dry preform has a weight per unit area of 100 g/m² to 1500 g/m², preferably from 500 g/m² to 1300 g/m².

Embodiment 21. The method of embodiment 15, wherein, after step b), the dry preform of polymeric material is deposited on a preform intended to form a composite product, and wherein step c) further comprises allowing the consolidation of the two preforms together.

Embodiment 22. The method of embodiment 15, wherein, after step b), the dry preform of polymeric material is deposited on a composite part previously consolidated, and wherein step c) further comprises allowing the melting of the dry preform and the consolidation or adhesion of the dry preform to the composite part together.

Embodiment 23. The method of embodiment 15, wherein the yarn or yarns comprise fillers, added to the step of formulation of the polymer or of the spinning of the yarn.

Embodiment 24. The method of embodiment 15, wherein the fillers comprise colored pigments.

Embodiment 25. The method of embodiment 15, wherein the fillers comprise static electricity dissipators.

Embodiment 26. The use of a dry preform obtained by knitting a rectilinear weft in 3D for the manufacture of a product, wherein the product comprises at least one zone comprising 90% to 100% polymeric material by volume.

Embodiment 27. The use of embodiment 26, wherein at least one zone of the final product comprises 95% to 100% polymeric material by volume.

Embodiment 28. The use of embodiment 26, wherein the polymeric material is chosen from polycarbonate, polypropylene, polyamide, polyurethane, PMMA, low density polyethylene terephthalate, polyetherimide, polyetheretherketone (PEEK), polyetherketone ketone (PEKK), or combinations thereof.

Embodiment 29. The use of embodiment 26, wherein the dry preform is produced with densities from 2 rows/cm to 7 rows/cm, preferably from 3 rows/cm to 6 rows/cm and from 2 columns/cm to 3 columns/cm.

Embodiment 30. The use of embodiment 26, wherein the dry preform has a weight per unit area of 100 g/m² to 1500 g/m², preferably from 500 g/m² to 1300 g/m².

Embodiment 31. The use of a dry preform obtained by knitting a rectilinear weft in 3D to coat a composite product of a layer comprising 90% to 100% of polymeric material by volume.

Embodiment 32. The use of embodiment 31, wherein at least one zone of the final product comprises 95% to 100% polymeric material by volume.

Embodiment 33. The use of embodiment 31, wherein the polymeric material is chosen from polycarbonate, polypropylene, polyamide, polyurethane, PMMA, low density polyethylene terephthalate, polyetherimide, polyetheretherketone (PEEK), polyetherketone ketone (PEKK), or combinations thereof.

Embodiment 34. The use of embodiment 31, wherein the dry preform is produced with densities from 2 rows/cm to 7 rows/cm, preferably from 3 rows/cm to 6 rows/cm and from 2 columns/cm to 3 columns/cm.

### EXAMPLES

The concepts described herein will be further described in the following Examples, which do not limit the scope of the invention described in the claims.

### Example 1: Complex and Weakly Loaded 3D Object

A 3D preform is knitted, in one piece, by the straight weft knitting method. The yarn is made of polycarbonate fibers. The densities are 4 rows/cm to 6 rows/cm and 2 columns/cm to 2.8 columns/cm. The weight per unit area is 500 g/m² to 1300 g/m².

The 3D preform is placed in a steel mold and counter-mold and heated to a temperature of 200° C. to 250° C. and to a pressure between 3 bars and 10 bars.

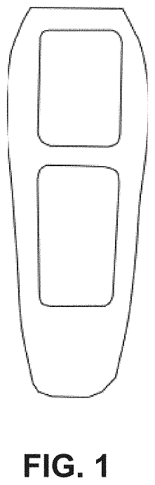

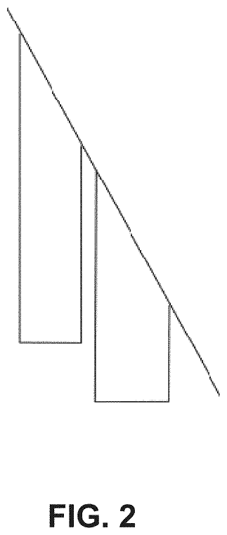

The finished product, illustrated in FIG. 1 (front view) and FIG. 2 (side view), has among its mechanical properties, a Young's modulus of 1 GPa to 4 GPa and a breaking strength of 40 MPa to 70 MPa.

Thanks to the invention, this type of object of complex shape can be obtained by controlling the thickness. The method consumes less material than traditional thermoforming methods because the thickness of the finished product can be controlled.

### Example 2: “Wing Tip Verrine”

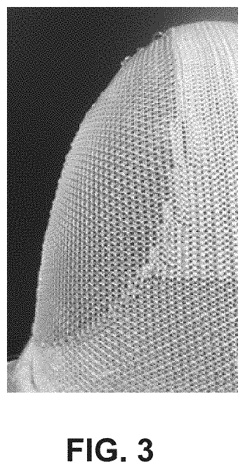

FIG. 3 illustrates a 3D preform knitted, in one piece, by the straight weft knitting method.

The preform has a zone that includes only polycarbonate fibers. The densities are 4 rows/cm to 6 rows/cm and 2 columns/cm to 2.8 columns/cm. The weight per unit area in this zone is 500 g/m² to 1300 g/m².

The same preform includes another composite zone composed of 20% to 45% by volume of glass fibers and 80% to 55% of polycarbonate. The densities are 3.6 rows/cm to 5 rows/cm and 2 columns/cm to 2.7 columns/cm. The weight per unit area in this zone is 550 g/m² to 1800 g/m². The two zones form a single knitted piece without sewing or joining. The two zones are an extension of each other and not two superimposed layers.

The 3D preform is placed in a steel mold with flexible counter-mold. The whole is heated to a temperature of 200° C. to 250° C. and to a pressure between 3 bars and 10 bars.

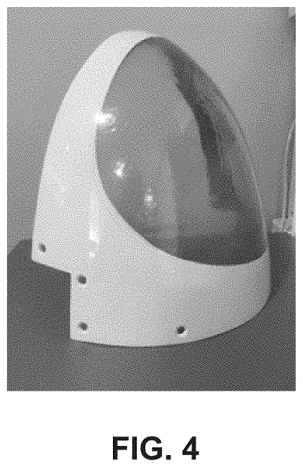

The finished product is shown in FIG. 4. The use of the appropriate polymer makes the pure polymer zone transparent after transformation.

The mechanical properties are, in the pure polymer zone, a Young's modulus from 1 GPa to 4 GPa and a breaking strength of 40 MPa to 70 MPa; and in the composite zone, a Young's modulus of 4 GPa to 19 GPa and breaking strength of 50 MPa to 600 MPa.

The choice of suitable polymers, combined with the technique according to the invention, makes it possible to obtain both a shape with the desired thicknesses and the desired transparency.

### Example 3: Surface Layer on Composite Body

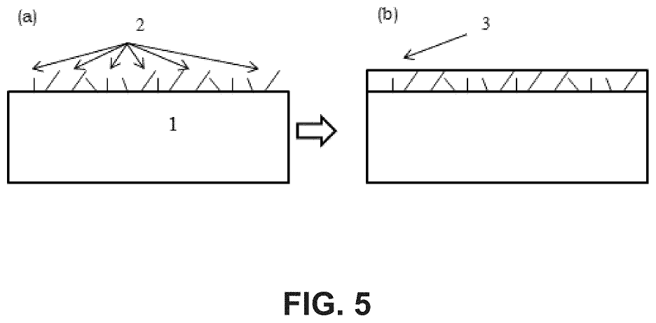

FIG. 5a illustrates a composite product 1 produced using a first knitted 3D preform, using mixed fibers composed of 33% to 45% glass fibers by volume and of 67% to 55% polycarbonate by volume.

The densities are 3 rows/cm to 6 rows/cm and 2 columns/cm to 2.8 columns/cm. The weight per unit area in this zone is 600 g/m²to 1500 g/m². Fibers 2 are present on the surface.

FIG. 5b illustrates the composite product 1 coated with a polymeric layer 3. The polymeric layer 3 is obtained using a second knitted 3D preform, using polyurethane fibers.

The densities are 3 rows/cm to 6 rows/cm and 2 columns/cm to 2.7 columns/cm. The weight per unit area in this zone is 100 g/m² to 200 g/m².

The two preforms are put together in a steel mold with flexible counter mold. The whole is heated to a temperature of 200° C. to 215° C. and to a pressure between 1 bar and 4 bars.

The invention makes it possible to modify the surface layer of a composite object. This can be advantageous to facilitate the addition of a paint or any other surface treatment. If the layer of pure polymer is sufficiently thick it can completely cover the fibers of the composite and isolate them from the outside.

Depending on the choice of polymeric material, it is possible to load it with colored pigments and thus create a coat of paint. In this case, for example, polycarbonate or PMMA will be chosen as the polymeric material.

The invention also makes it possible to charge the polymeric material with static electricity dissipators, which gives the finished product an antistatic layer.

### Example 4: Surface Layer Added Later on Composite Body

FIG. 5a illustrates a composite product 1 produced according to any technique for producing composite materials.

FIG. 5b illustrates the composite product 1 coated with a polymeric layer 3. The polymeric layer 3 is obtained using a knitted 3D preform, using fibers whose melting temperature is lower than the melting temperature of the matrix of the composite product 1 (e.g. PMMA).

The densities are 3 to 6 rows/cm and 2 to 2.7 columns/cm. The weight per unit area of this preform is 100 to 200 g/m2.

The knitted preform is draped over the composite product 1. The 3D preform is placed in a steel mold with flexible counter-mold. The whole is heated to a temperature of 140 to 190° C. and to a pressure between 1 bar and 4 bars.

The invention makes it possible to modify the surface layer of a composite object. This can be advantageous to facilitate the addition of a protective layer (equivalent to a varnish), a paint or any other surface treatment. If the layer of pure polymer is sufficiently thick it can completely cover the fibers of the composite and isolate them from the outside.

Depending on the choice of polymeric material, it is possible to load it with colored pigments and thus create a coat of paint. In this case, for example, polycarbonate or PMMA will be chosen as the polymeric material.

The invention also makes it possible to charge the polymeric material with static electricity dissipators, which gives the finished product an antistatic layer.

The invention is not limited to these examples and other functionalities can also be achieved without departing from the scope of the present invention.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A method for manufacturing a polymeric product, wherein the method comprises the following steps:
a) weft knitting a yarn or a set of yarns, wherein the yarn or set of yarns comprise 90% to 100% polymeric material by volume;
b) production of a dry preform in three dimensions, and in a continuous piece; the preform corresponding to the shape of a finished product to be obtained;
c) consolidation of the preform by heating under pressure to reach at least the melting point temperature of the 90% to 100% polymeric material, and
d) cooling of the finished product.

2. The method of claim 1, wherein the weft knitting is carried out by knitting a straight weft.

3. The method of claim 1, wherein at least one zone of the final product comprises 95% to 100% polymeric material by volume.

4. The method of claim 3, wherein the polymeric material is chosen from polycarbonate, polypropylene, polyamide, polyurethane, PMMA, low density polyethylene terephthalate, polyetherimide, polyetheretherketone (PEEK), polyetherketone ketone (PEKK), or combinations thereof.

5. The method of claim 1, wherein the dry preform is produced with densities from 2 rows/cm to 7 rows/cm, preferably from 3 rows/cm to 6 rows/cm and from 2 columns/cm to 3 columns/cm.

6. The method of claim 1, wherein the dry preform has a weight per unit area of 100 g/m² to 1500 g/m², preferably from 500 g/m² to 1300 g/m².

7. The method of claim 1, wherein, after step b), the dry preform of polymeric material is deposited on a preform intended to form a composite product, and wherein step c) further comprises allowing the consolidation of the two preforms together.

8. The method of claim 1, wherein, after step b), the dry preform of polymeric material is deposited on a composite part previously consolidated, and wherein step c) further comprises allowing the melting of the dry preform and the consolidation or adhesion of the dry preform to the composite part together.

9. The method of claim 1, wherein the yarn or yarns comprise fillers, added to the step of formulation of the polymer or of the spinning of the yarn.

10. The method of claim 1, wherein the fillers comprise colored pigments.

11. The method of claim 1, wherein the fillers comprise static electricity dissipators.

12. The use of a dry preform obtained by knitting a rectilinear weft in 3D for the manufacture of a product, wherein the product comprises at least one zone comprising 90% to 100% polymeric material by volume.

13. The use of claim 12, wherein at least one zone of the final product comprises 95% to 100% polymeric material by volume.

14. The use of claim 12, wherein the polymeric material is chosen from polycarbonate, polypropylene, polyamide, polyurethane, PMMA, low density polyethylene terephthalate, polyetherimide, polyetheretherketone (PEEK), polyetherketone ketone (PEKK), or combinations thereof.

15. The use of claim 12, wherein the dry preform is produced with densities from 2 rows/cm to 7 rows/cm, preferably from 3 rows/cm to 6 rows/cm and from 2 columns/cm to 3 columns/cm.

16. The use of claim 12, wherein the dry preform has a weight per unit area of 100 g/m² to 1500 g/m², preferably from 500 g/m² to 1300 g/m².

17. The use of a dry preform obtained by knitting a rectilinear weft in 3D to coat a composite product of a layer comprising 90% to 100% of polymeric material by volume.

18. The use of claim 17, wherein at least one zone of the final product comprises 95% to 100% polymeric material by volume.

19. The use of claim 17, wherein the polymeric material is chosen from polycarbonate, polypropylene, polyamide, polyurethane, PMMA, low density polyethylene terephthalate, polyetherimide, polyetheretherketone (PEEK), polyetherketone ketone (PEKK), or combinations thereof.

20. The use of claim 17, wherein the dry preform is produced with densities from 2 rows/cm to 7 rows/cm, preferably from 3 rows/cm to 6 rows/cm and from 2 columns/cm to 3 columns/cm.
